(19) United States
(12) Patent Application Publication
(10) Pub. No.: US 2005/0279956 A1
(43) Pub. Date: Dec. 22, 2005

(54) Valve with reliable opening indication

(76) Inventors: Siegfried Berger, Schlierbach (DE); Harald Petermann, Lichtenwald (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/153,565

(22) Filed: Jun. 14, 2005

(30) Foreign Application Priority Data
Jun. 16, 2004 (DE) 10 2004 028 968.9

(51) Int. Cl. F16K 31/44

(52) U.S. Cl. 251/77

(57) ABSTRACT

A valve for gaseous media has a single magnetic drive and two valve closure elements assigned to it. These open in close succession when operated by the magnetic drive. A signaler is adjusted to produce a signal between the opening time of the first valve closure element and that of the second valve closure element. This applies both during opening and closing of valve.

### BACKGROUND OF THE INVENTION

a) Field of the Invention

The invention is directed to a valve, prescribed especially for gaseous fluid media.

b) Description of the Related Art

There is a demand for gas valves which on the one hand reliably block a gas stream and therefore meet safety requirements, and on the other hand have a low flow resistance in the opened state. To increase safety, two valve closure elements and two related valve seats are generally provided, in which attempts have invariably been made to then operate both valve closure elements with a single drive.

For example, a gas valve is known from EP 1 084 357 B1 that has two valve closure elements that are movable independently of each other within limits and can be operated with a single common magnetic drive. The valve closure elements are arranged concentrically to each other. The first or outer valve closure element is connected to the edge of a container, which extends into a magnetic drive. The container consists of stainless steel or another insignificantly magnetic material. A closure spring is supported against the edge of the container on the one hand and against the valve housing on the other hand. Because of this, the first outer valve closure element is forced against an annular flat surface of a housing intermediate wall that encloses a passage opening and forms a first valve seat. At the same time, it forms a second valve seat for the second inner valve closure element arranged in the interior of the container. The second valve closure element is connected to a cylindrical magnetic armature that extends into the interior of the container. A closure spring, assigned to the second valve closure element, is supported on one end on a bead formed on the container, and on the other end on the second valve closure element.

If the magnetic circuit is excited, the armature lying in the container is moved upward, i.e., away from the valve seat. The second inner valve closure element is therefore initially opened. With its upper flat front, the armature immediately runs along the bottom of the container and on the rest of its path also carries the container upward, so that the first outer valve closure element also opens.

Because of combination of the two valve seats with each other, this arrangement leads to a relatively low flow resistance and therefore a limited pressure drop via the open valve. In addition, a single magnetic drive is sufficient. However, manufacture turns out to be relatively exacting. This justifies the search for simplified solutions.

In addition, there is often a requirement for a signal that marks the valve open position, wherein opening of the valve must not remain unreported. Special safety requirements are therefore imposed on this signal. Such a signal can only be derived with difficulty from the valve according to EP 1 084 357 B1.

A double seat gas valve with two disk-like valve closure elements is also known from DE 25 10 788. In the flow direction the first larger, and therefore outer, valve closure element is connected to a closure spring which forces it against its valve seat. The smaller second, and therefore inner, valve closure element lying beneath it is biased in the closure direction with a spring that is supported at one end against the second valve closure element and at the other end on the first valve closure element. A continuation of the second lower valve closure element extends into a corresponding downward opened, but upward closed blind hole of the first valve closure element. A push rod is provided for opening of the valve closure elements. This push rod sits in a blind hole of the lower valve closure element and forces it, as required, away from the valve seat. The second valve closure element initially traverses the clearance present relative to the first valve closure element, until its continuation arrives at the bottom of the blind hole of the first valve closure element. As soon as this occurs, the first valve closure element is now also opened.

When the pressure movement of the push rod begins, the second valve closure element and then the first valve closure element are opened. This configuration, however, requires a drive operating with pressure, but magnetic drives are preferred which instead operate by tension.

A valve operated by a pressure medium is also known from JP 58134284 A, which has two, i.e., a first outer and a second inner, valve closure elements. The inner valve closure element is limited in movement against a first valve closure element. A closure spring biases it away from the first valve closure element on the valve seat.

The valve seat is formed by a flat annular surface enclosing a passage opening on which both the second inner and the first outer valve closure element can sit. At one site of the flat surface, lying between the two valve closure elements in the closed position, is connected a line which therefore communicates with the internal space enclosed by the two closed valve closure elements. This internal space can be flooded in the closed position with a purging gas in order to avoid penetration of hot fluid from the upstream side through the two closed valve elements to the downstream side.

There is a need for a simple, reliable valve for fluids, especially gaseous media, with which gas streams can be reliably released and blocked, wherein the pressure drop via the valve and also the manufacturing demands for the valve are low, and a reliable opening signal for indication of the valve open position is to be generated.

### SUMMARY OF THE INVENTION

The valve according to the invention has two valve closure elements arranged concentrically to each other, to which a common valve seat or two concentrically arranged valve seats connected to each other, or also separated from each other, are assigned. The second valve closure element is mounted to move axially on the first valve closure element. The drive is connected to the first valve closure element and opens both valve closure elements. It initially opens the outer valve closure element and then entrains the inner one.

This concept permits the tapping of a reliable opening signal in the simplest manner, by assigning a signaler to the first valve closure element. This can record the movement of the valve closure element before the second valve closure element opens. Preferably, it therefore has its switching point within the axial clearance that the second valve closure element has relative to the first valve closure element. It therefore generates a valve opening signal before the inner second valve closure element opens and therefore the gas stream is actually released. This is a safety feature. On the other hand, the valve opening signal is still present on closure of the valve, when the second valve closure element is already positioned on its seat and the gas stream is therefore fully blocked. It only disappears when the first valve closure element also moves further onto the valve seat and therefore closes.

At the same time, the valve fulfills the safety requirements of a double gas valve. If one of the two valve seats is not entirely tight, this does not adversely affect the overall tightness of the valve.

A test channel can branch off between the valve seats, in order to be able to conduct a tightness test with the valve, which tests both valve seats separately. If the valve, for example, is closed, and a gradual pressure increase occurs in the test channel, the first valve closure element and the first valve seat are not working together correctly. If, on the other hand, with the valve closed, a gas pressure is applied, both on the input side and via the test channel in the intermediate space and the gas pressure gradually drops in the intermediate space, the second valve closure element and the second valve seat are not working correctly together. The test is to be conducted with the closed valve and can therefore be automatically conducted from time to time in a gas installation by an appropriate test routine in the installed state.

A main advantage of the valve according to the invention lies in the possibility of providing a simple magnetic drive, as is otherwise used for simple valves. The tension rod, connected to the first valve closure element, operates as in an ordinary simple valve. The required air gap is small.

In addition, the valve opening signal can be tapped in the simplest manner. For example, it can be obtained by monitoring the armature position. It is sufficient to provide a simple mechanical end switch that responds as soon as the armature moves out of its closed position. Instead of a mechanical switch, however, an electronic proximity switch can also be provided which monitors damping of a sensor coil excited with alternating voltage. When the armature approaches this sensor coil by a certain extent, a corresponding evaluation circuit can produce a signal. This variant has the advantage of electronic adjustability and simple sealing.

### BRIEF DESCRIPTION OF THE DRAWINGS

Additional details of advantageous modifications of the invention are apparent from the drawing, the description, or the claims.

Embodiments of the invention are shown in the following drawings:

FIG. 1 shows the valve according to the invention in a schematic diagram, cut longitudinally;

FIG. 2 shows the valve closure elements of the valve according to FIG. 1, cut along a line II-II, with a viewing direction toward the inner lower valve closure element;

FIG. 3 shows the valve according to FIG. 1 at the beginning of its opening process, in a longitudinally-cut schematic diagram;

FIG. 4 shows the valve according to FIGS. 1 and 2 in the open position;

FIG. 5 shows a modified first and second valve closure element in an easily assembled variant and in a longitudinally cut schematic diagram;

FIG. 6 shows a modified variant of the valve closure elements in a longitudinally cut schematic diagram; and

FIG. 7 shows a proximity switch, serving as a signaler, for incorporation in the magnetic circuit in a sectional schematic diagram.

### DETAILED DESCRIPTION OF THE DRAWINGS

A valve 1, which can be viewed as a simple valve, is shown in FIG. 1. It has a single magnetic drive 2 that opens valve 1 when current is applied.

A valve housing 3, with an inlet connection 4, an outlet connection 5 and an intermediate wall 6, belongs to valve 1. The latter has a passage opening 7 which is enclosed by a flat annular surface 8 and an upward-facing rib 9 that tapers to a tip. Rib 9 forms a first valve seat 11, while annular surface 8 forms a second valve seat 12.

A first valve closure element 14 is assigned to the first valve seat 11, which is formed by a cup-shaped, plate-like, or bell-shaped element whose lower edge is provided with a seal 15. This seals on rib 9. A second valve closure element 16, for example, in the form of a flat disk, is assigned to the second valve seat 12, which carries on its outer edge a downward-facing seal 17. In the closed position, this lies on annular surface 8.

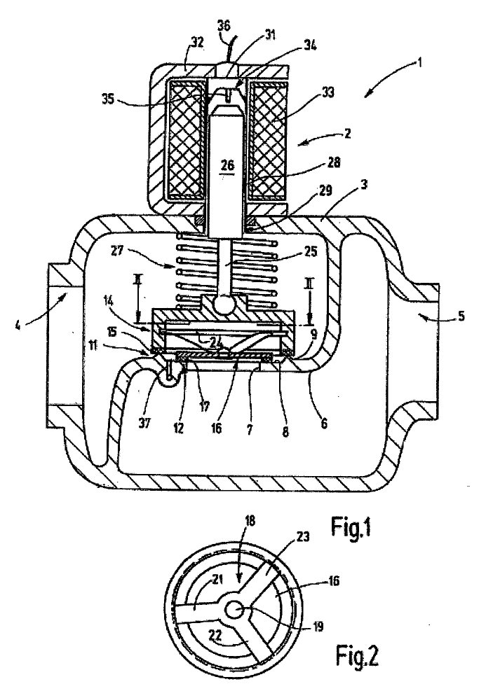

The first valve closure element 14 and the second valve closure element 16 are mounted to move axially, one beneath the other (vertically in FIG. 1). A mounting spring 18, which is shown as an example in FIG. 2, is used for mounting in the variant according to FIG. 1. For example, it is secured in the center with a rivet 19 on the second valve closure element 16, with arms 21, 22, 23 extending radially in arched fashion like leaf springs away from the valve closure element 16. The ends of the mounting spring 18 or arms 21, 22, 23 engage in a groove 24 formed on the inside of the first valve closure element 14, in which they lie with some clearance.

The first valve closure element 14 is connected to an armature 16 of magnetic drive 2 via a pull rod 25. The connection preferably has little play or is free of play. However, relative pivoting movements are possible. For example, the tension rod 25 has a ball-like head on its end that sits in a corresponding socket formed in the first valve closure element 14. A closure spring 27 sits on the upper side of the valve closure element 14 and is supported there. With its other end, it is supported against the inside of valve housing 3 and therefore biases the valve closure element 14 against valve seat 11. The mounting spring 18 also biases the valve closure element 16 against valve seat 12.

The armature 26 extends into a sleeve 28, secured gas-tight in an opening 29 in valve housing 3. On its upper end, the sleeve has a gas-tight flux concentrating component 31. The sleeve and the flux concentrating component are enclosed by a yoke 32, in which a magnetic coil 33 sits concentrically on sleeve 28.

A signaler 34 is accommodated in the flux concentrating component 31, which is formed by means of a mechanical switch. A push rod 35 that operates its switching element extends into the intermediate space enclosed by the flux concentrating component 31 and the front of the armature 26, in which it is positioned at a limited spacing relative to the front of the armature 26 when the valve is closed. The push rod and the switching element of the switch are adjusted so that the switch is operated as soon as the first valve closure element 14 is lifted from its valve seat 11, while the second valve closure element 16 still lies on its valve seat 12. The switching signal is guided outward through a corresponding signal line 36. Adjustment of the switching point can be effected, for example, by adjusting the tension rod 25 on armature 26. For example, the tension rod 25 is screwed into a threaded hole of armature 26, in which the screwed-in position is adjustable. As an alternative, an adjustable stop screw can be arranged on the upper end of the armature 26 that cooperates with push rod 35. As an additional alternative, the push rod 35 itself or the switching element assigned to it can be adjusted.

In this respect, all essential features of the basic design of valve 1 are described. However, it is noted that, as an alternative or supplement, a test channel 37 can branch off between the valve seats 11, 12, which is guided outward. The test channel can be used to deliberately place the internal space enclosed by the valve closure elements 14, 16 under gas pressure in order to conduct the test routine. In addition, the test channel 37 can be used to branch off ignition gas.

In a rest position, the closure spring 27 forces the first valve closure element 14 against its valve seat 11, so that a tight gas-sealing seat is formed. The mounting spring 18 is dimensioned and curved, so that the second valve closure element 16 also sits on its second valve seat 12 under bias. The force applied by the mounting spring 18 is less than the force of the closure spring 27. The spring characteristic of the mounting spring 18, however, can be steeper.

In this state, the valve 1 is tight. Tightness can be tested by exposing the inlet connection 4 to pressure and monitoring the pressure produced in test channel 37. If the pressure in test channel 37 rises, a leak of the first valve closure element 14 or its valve seat 11 is present.

Another pressure test can be conducted by exposing the test channel 37 to a test pressure when valve 1 is closed, while the inlet connection 4 and the outlet connection 5 are pressure-free. If the test pressure drops with time, a leak of the valve closure element 14 or the valve closure element 16 is present. Whereas tightness of the valve closure element 14 was found previously, the valve closure element 16 is not tight. Both tests can be conducted in the incorporated state in an existing unit. In addition, it is also possible to expose the outlet connection 5 to a counterpressure on a test bench, in order to observe the pressure trend that is established in the test channel 37. If the pressure rises, the valve closure element 16 is not tight or the mounting spring 18 is not exerting sufficient pressure.

Opening of the valve 1 occurs as follows:

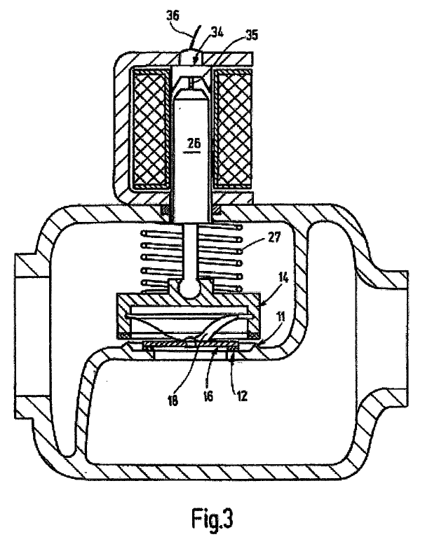

Magnetic coil 33 is exposed to current, which therefore causes armature 26 to move upward. The first phase of movement is shown in FIG. 3. The valve closure element 14 is raised from its valve seat 11. However, the second valve closure element 16 still rests on its second valve seat 12. Gas flow is still not possible. However, the upper end of the armature 26 is already in contact with the push rod 35 and has moved it upward. This movement has led to activation of the signaler 34 as, for example, opening or closing or switching of a corresponding contact. A valve opening signal is therefore present on the signal line 36. This can be used in order to start ignition devices, monitoring devices or the like.

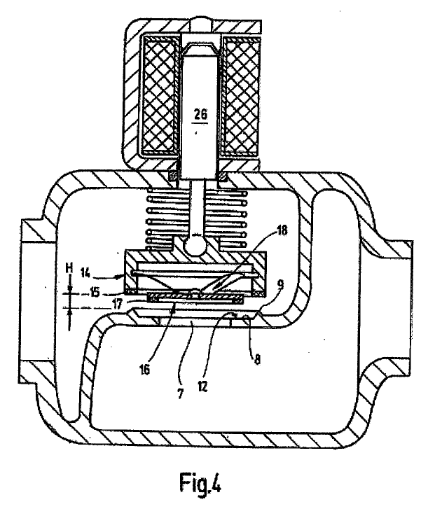

The armature 26 moves the valve closure elements 14, 16 against the force of closure spring 27 further upward until the mounting spring 18 also raises the second valve closure element 16 from its valve seat 12. This state is shown in FIG. 4. As is apparent, the relative lift of the valve closure elements 14, 16 established by the mounting spring 18 against each other is much less than the total lift of armature 26. For example, the relative lift of the second valve closure element 16 is only a third or fourth or an even smaller fraction of the opening lift of the first valve closure element 14.

As is apparent, the passage opening 7 is substantially freed by the valve closure elements 14, 16. Roughly the same height difference situated between rib 9 and the annular surface 8 is also present between the bottoms of seals 15, 17. This produces an almost undisturbed gas flow and therefore a low pressure drop in the passage opening 7.

FIGS. 1 to 4 serve to explain the basic principle of valve 1. FIG. 5, on the other hand, is concerned with design details that have significant advantages from a manufacturing standpoint. The outer valve closure element 14 and the inner second valve closure element 16 can be connected via a locking device 38. At the same time, this forms a stop 39 that definitively limits the lift of the second valve closure element 16 against the first valve closure element 14. In addition, the locking device 38 can serve to hold the valve closure element 16 against the valve closure element 14. The design, in detail, is as follows:

The valve closure element 14 has an essentially cylindrical inner peripheral surface, provided with an annular groove 41. The disk-like element forming the valve closure element 16 is provided on its cylindrical edge with an annular groove 42. The annular groove 41 is wider in the axial direction than annular groove 42. The annular grove 42 is of a depth such that a snap ring 43 can be completely pressed into annular grove 42. The snap ring is, for example, a spring ring provided with a slit. In FIG. 5 it is shown in its relaxed position. The depth of the annular groove 41 is dimensioned such that the snap ring 43 lies in annular groove 41 with limited play. The snap ring 43, on the other hand, lies with only slight or almost no radial play in annular groove 42. The valve closure element 14 can be provided with an entry slope, i.e., a conical surface 44, on the side facing seal 15. A closure spring 45 that replaces the mounting spring 18 can be arranged between the valve closure elements 14, 16. Bias of the mounting spring 45 is possible here. A relatively soft mounting spring 45 can be used, which biases the valve closure element 16 against the stop 39.

For assembly, only the mounting spring 45 is inserted into the internal space enclosed by the first valve closure element 14, [and] the second valve closure element 16, provided with the snap ring 43, is pushed together with it into the internal space of the first valve closure element 14, until it locks. Assembly is thus completed.

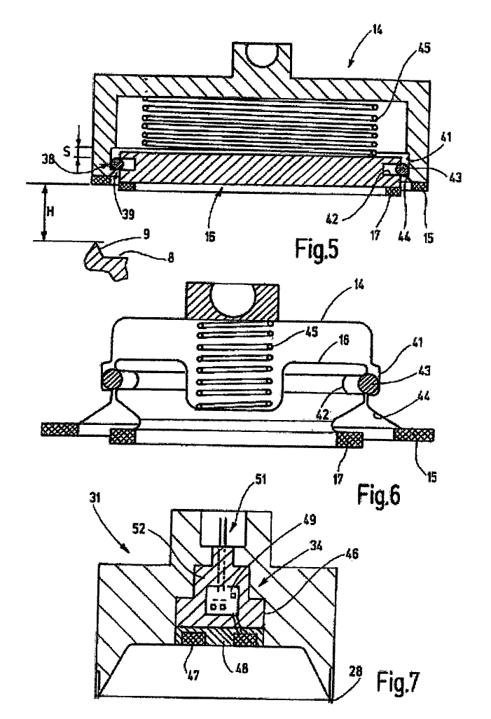

A similar variant is shown in FIG. 6. This is essentially identical in function. The difference consists only of the fact that the first valve closure element 14 and the second valve closure element 16 are formed by molded sheet metal parts. The annular grooves 41, 42 can be formed by rolled beads. Otherwise, the above description, based on the same reference numbers, applies accordingly.

FIG. 7 shows the flux concentrating component 31 with signaler 34, designed here as an electronic signaler. The flux concentrating component 31 has a hole 46 to accommodate the signaler 34, and the hole is multiply stepped, conical, or can be designed in some other way. A sensor coil 47, to which a separate flux concentrating component, for example, a ferrite core 48, can be assigned, sits in hole 46. The sensor coil 47 is also assigned an electronic evaluation circuit 49 connected to the connection lines of the sensor coil 47. The evaluation circuit 49 permanently or periodically exposes the sensor coil 47 to an alternating voltage and measures the attenuation of the sensor coil 47. If the armature 26 approaches with its front side, the attenuation increases. The evaluation circuit 49 compares the measured attenuation with a threshold value and produces a corresponding switching signal at its outlet connections 51 as soon as approach of the armature 26 goes below a limit value. The hole 46 is filled with an electrically insulating sealing compound 52 that ensures gas tightness of the flux concentrating component 31. Adjustment of the circuit to a desired switching point can also be effected via the outlet connections 51, if this is required.

The valve 1 for gaseous media has a single magnetic drive 2 and two valve closure elements 14, 16 assigned to it. These open in close succession when operated by the magnetic drive 2. A signaler 34 is adjusted to produce a signal between the opening time of the first valve closure element 14 and that of the second valve closure element 16. This applies both during opening and closing of valve 1.

While the foregoing description and drawings represent the present invention, it will be obvious to those skilled in the art that various changes may be made therein without departing from the true spirit and scope of the present invention.

1. A valve for gaseous media comprising:
a valve housing comprising:
an inlet connection;
an outlet connection; and
an intermediate wall, wherein an opening with a first valve seat, and concentrically to it, a second valve seat, are arranged, both valve seats being arranged on the side of the intermediate wall toward the inlet connection, and the first valve seat being larger than the second valve seat,
with a first valve closure element upstream that is assigned to the first valve seat and is mounted to move along a valve opening path, and with a second valve closure element downstream, assigned to the second valve seat,
in which the second valve closure element is mounted to move axially on the first valve closure element, the axial mobility of the second valve closure element on the first valve closure element being significantly smaller than the valve opening lift,
with a drive, assigned to the first valve closure element, in order to open and close both valve closure elements,
with a signaler, assigned to the first valve closure element, and which reports lifting of the first valve closure element from the first valve seat.

2. The valve according to claim 1, wherein the first and second valve closure elements have a stop that limits relative mobility of the first and second valve closure elements with reference to each other.

3. The valve according to claim 1, wherein the first valve closure element is designed closed.

4. The valve according to claim 1, wherein the second valve closure element is designed closed.

5. The valve according to claim 1, wherein the first and second valve seat are designed to transition seamlessly one into the other.

6. The valve according to claim 1, wherein the first and second valve seats are arranged in a common plane.

7. The valve according to claim 1, characterized by the fact that a tightness test line is formed between the valve seats.

8. The valve according to claim 1, wherein a first closure spring is assigned to the first valve closure element, which is supported at one end on the valve closure element and at the other end on the valve housing.

9. The valve according to claim 1, wherein a second closure spring is assigned to the second valve closure element, which is supported at one end on the first valve closure element and at its second end on the second valve closure element.

10. The valve according to claim 2, wherein the valve opening position the second closure spring biases the valve closure element against the stop.

11. The valve according to claim 8, wherein the second closure spring applies a spring force in the closure position that is smaller than the closure force of the first closure spring.

12. The valve according to claim 8, wherein the second closure spring has a steeper spring characteristic than that of the first closure spring.

13. The valve according to claim 1, wherein the signaler is arranged or adjusted so that it responds before the second valve closure element is lifted from the second valve seat.

14. The valve according to claim 1, wherein the signaler is designed to record the position of an armature that belongs to a magnetic drive that forms the drive device.

15. The valve according to claim 14, wherein the signaler is a mechanical switch cooperating with armature.

16. The valve according to claim 14, wherein the signaler is an electronic switch cooperating with armature.

17. The valve according to claim 16, wherein the electronic switch is a proximity switch.

18. The valve according to claim 1, wherein the second valve closure element is connected to the first valve closure element with a locking connection.
